(19) United States
(12) Patent Application Publication
(10) Pub. No.: US 2018/0174397 A1
(43) Pub. Date: Jun. 21, 2018

(54) DEVICE, METHOD, AND COMPUTER PROGRAM FOR PROVIDING GAME SERVICE

(71) Applicant: VISUALSHOWER CORP., Gangnam-gu, Seoul (KR)

(72) Inventor: Hong Kwan PARK, Mapo-gu, Seoul (KR)

(73) Assignee: VISUALSHOWER CORP., Gangnam-gu, Seoul (KR)

(21) Appl. No.: 15/579,880

(22) PCT Filed: Jun. 7, 2016
(86) PCT No.: PCT/KR2016/005974

§ 371 Date: Dec. 5, 2017

(30) Foreign Application Priority Data
Jun. 5, 2015 (KR) 10-2015-0080036

(51) Int. Cl. G07F 17/32; A63F 13/73; G06F 17/18

(52) U.S. Cl. CPC G07F 17/3225; A63F 13/73; A63F 2001/008; G06F 17/18; G07F 17/3251

(57) ABSTRACT

A game service providing method for providing a game service by a game service providing apparatus, the game service providing method including, receiving identification information of a card reader connected to a user terminal from the user terminal, receiving level information of the card reader from a database by using the identification information of the card reader, receiving, from the user terminal, first card information read by the card reader as target card information, and receiving second card information as first source card information, and changing a property of the first card by using the second card information, so that the changing involves changing the property of the first card or setting a property change success rate of the first card according to the level information of the card reader.

### CROSS REFERENCE TO RELATED APPLICATIONS

This application is the National Stage of International Application No. PCT/KR2016/005974, having an International Filing Date of 7 Jun. 2016, which designated the United States of America, and which International Application was published under PCT Article 21 (2) as WO Publication No. 2016/195447 A1, and which claims priority from and the benefit of Korean Application No. 10-2015-0080036, filed on 5 Jun. 2015, the disclosures of which are incorporated herein by reference in their entirety.

### BACKGROUND

### 1. Field

Aspects of the presently disclosed embodiment relate to game service providing apparatuses, methods, and computer programs.

### 2. Brief Description of Related Developments

Online game items are tools that exist on games in various ways so as to add pleasure to users enjoying games through the Internet by wire or by wireless.

Such items are traded online and are traded offline in the form of cards, toys, and the like. Various methods of acquiring items traded in the form of cards, toys, and the like on online games are being developed.

### SUMMARY

Aspects of the presently disclosed embodiment provide game service providing apparatuses, methods, and computer programs.

According to an aspect of the presently disclosed embodiment, there is provided a game service providing method for providing a game service by a game service providing apparatus, the game service providing method including: receiving identification information of a card reader connected to a user terminal from the user terminal; receiving level information of the card reader from a database by using the identification information of the card reader; receiving, from the user terminal, first card information read by the card reader as target card information and receiving second card information as first source card information; and changing a property of the first card by using the second card information, wherein the changing includes changing the property of the first card or setting a property change success rate of the first card differently according to the level information of the card reader.

According to aspects of the presently disclosed embodiment, it is possible to provide game service providing apparatuses, methods, and computer programs.

### BRIEF DESCRIPTION OF THE DRAWINGS

FIG. 1 is a block diagram schematically illustrating a game service providing apparatus according to an aspect of the presently disclosed embodiment.

FIG. 2 schematically illustrates a card reader 30.

FIG. 3 is a flow diagram illustrating a game service providing method according to an aspect of the presently disclosed embodiment.

FIG. 4 is a flow diagram illustrating a game service providing method according to another aspect of the presently disclosed embodiment.

### DETAILED DESCRIPTION

According to an aspect of the presently disclosed embodiment, a game service providing method for providing a game service by a game service providing apparatus includes: receiving identification information of a card reader attached to a user terminal from the user terminal; receiving level information of the card reader from a database by using the identification information of the card reader; receiving, from the user terminal, first card information read from a first card by the card reader as target card information and receiving second card information read from a second card by the card reader as first source card information; and changing a property of the first card by using the second card information and the level information of the card reader, wherein the changing includes changing the property of the first card or setting a property change success rate of the first card differently according to the level information of the card reader.

The advantages and features of the presently disclosed embodiment and methods for achieving the same will become apparent from the following aspects that are described in detail in conjunction with the accompanying drawings. However, it should be understood that these aspects are not construed as limited to the illustrated forms and include all changes, equivalents, or alternatives within the idea and the technical scope of the presently disclosed embodiment. The following aspects are provided so that this disclosure will be thorough and complete, and will fully convey the scope of the disclosed embodiment to those skilled in the art. In the following descriptions, descriptions of well-known functions and constructions will be omitted if they are considered to unnecessarily obscure the gist of the presently disclosed embodiment.

The terminology used herein is for the purpose of describing particular aspects only and is not intended to limit the scope of the presently disclosed embodiment. As used herein, the singular forms “a”, “an”, and “the” are intended to include the plural forms as well, unless the context clearly indicates otherwise. It will be understood that terms such as “comprise”, “include”, and “have”, when used herein, specify the presence of stated features, integers, steps, operations, elements, components, or combinations thereof, but do not preclude the presence or addition of one or more other features, integers, steps, operations, elements, components, or combinations thereof. It will be understood that although the terms “first”, “second”, etc. may be used herein to describe various components, these components should not be limited by these terms. These components are only used to distinguish one component from another.

The terms “communication”, “communication network”, “Internet network”, and “network” used herein may be used as the same meaning. The above terms mean a wired or wireless local and wide area data transmission and reception network that enables files to be transmitted and received between a user terminal, terminals of other users, and a download server.

In the present specification, when one component “transmits” data to another component, it means that the component may transmit the data directly to the other component, or may transmit the data to the other component through at least one other component.

In contrast, when one component “directly transmits” data to another component, it means that the data is transmitted to the other component without passing through another component.

The terms “unit” and “module” used herein may mean a functional and structural combination of hardware for performing the technical spirit of the presently disclosed embodiment and software for driving the hardware. For example, the term “module” may mean a logical unit of predetermined codes and hardware resources for performing the predetermined codes, and it will be apparent to those skilled in the art that the module is not limited to physically connected codes or one type of hardware.

Hereinafter, aspects of the presently disclosed embodiment will be described in detail with reference to the accompanying drawings, and in the drawings, like reference numerals denote like elements, and a redundant explanation thereof will not be provided herein.

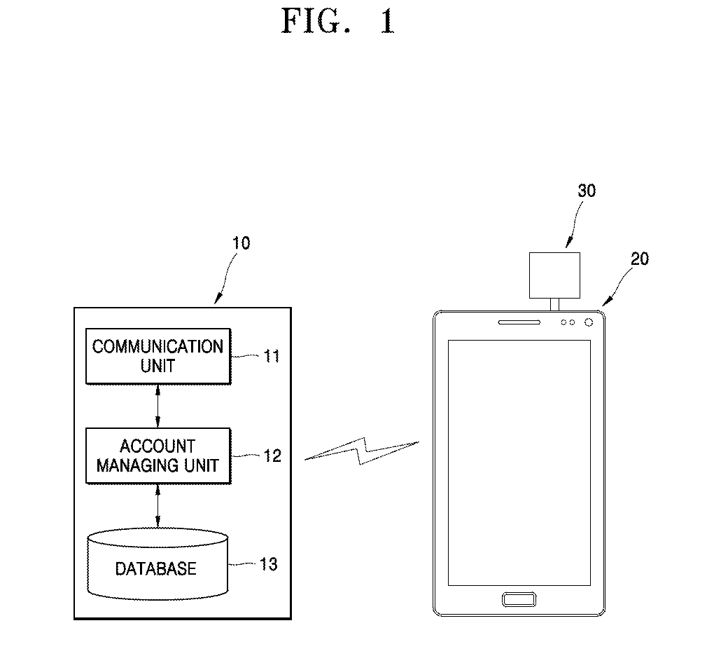

FIG. 1 is a block diagram schematically illustrating a game service providing system according to an aspect of the presently disclosed embodiment.

Referring to FIG. 1, a game service providing system according to an aspect of the presently disclosed embodiment may include a game service providing apparatus 10, a user terminal 20, and a card reader 30.

The user terminal 20 may use the card reader 30 attached to the user terminal 20 to read information from a card to be read, and transmit the read information to the game service providing apparatus 10. The user terminal 20 may communicate with the game service providing apparatus 10 through a communication network. The user terminal 20 may execute a game program downloaded from the game service providing apparatus 10 and provide a game to a user while communicating with the game service providing apparatus 10.

The user terminal 20 may refer to an electronic device that may use a communication service in wired/wire less communication environments. Herein, the user terminal 20 may be a user's personal computer or a user's portable terminal. Although the user terminal 20 is illustrated as a smart phone in FIG. 1, the inventive concept is not limited thereto. The user terminal 20 may be any electronic device that may use a communication service and may execute a game program provided in the game service providing apparatus 10.

When the card reader 30 is attached to the user terminal 20, the user terminal 20 may read the identification information of the card reader 30 from the card reader 30. The card reader 30 may be attached/detached to/from a port of the user terminal 20. For example, the card reader 30 may be attached to an audio pin of the user terminal 20 and may receive power from the user terminal 20 through the audio pin. The user terminal 20 may transmit the identification information of the card reader 30 to the game service providing apparatus 10, receive the level information of the card reader 30 from the game service providing apparatus 10 in response thereto, and display the received level information on a screen thereof.

The game service providing apparatus 10 may include a communication unit 11, an account managing unit 12, and a database 13. The communication unit 11 may communicates with the user terminal 20 to transmit/receive packet data. The communication unit 11 may receive the identification information of the card reader 30 front the user terminal 20 and receive the information read from the card to be read by using the card reader 30.

The identification information of the card reader 30 may be unique identification information given to each card reader 30 existing in the spot, and may be information used to specify the card reader 30. Information about the card reader 30, such as user account information associated with the card reader 30 and level information of the card reader 30, may be stored in the database 13 in association with the identification information of the card reader 30. The database 13 may store a card reader account, may include a plurality of fields for the card reader account, and may store, in each field, a card reader identification number, user account information associated with the card reader, and/or card reader level information. A level may be given to the card reader 30, and the level of the card reader 30 may be changed by a level change source (e.g., a source card including a function of changing the level of the card reader).

The user may proceed to play a game by using the card read by using the card reader 30, and the level of the card reader 30 may affect the progress of the game. For example, the level of the card reader 30 may determine a level change success rate when determining the performance of an item included in the card, or when changing the level of a target card by using a source card.

The information read by the card reader 30 may include payment code read information of the card or card read information. However, the inventive concept is not limited thereto, and the payment code read information may be read by a payment code reader (not illustrated) and then transmitted to the game service providing apparatus 10. The payment code reader (not illustrated) may be attached to the user terminal 20 or may be attached to a seller's terminal (not illustrated).

The card to be read may have a radio frequency module between the covers thereof, and a payment code may be displayed on the cover. The payment code reader (not illustrated) may read the billing code displayed on the card cover to acquire the payment code read information. The payment code may include, but is not limited to, a code that may be two-dimensionally displayed, such as a bar code or a QR code.

The card reader 30 may acquire the card read information from the radio frequency module provided between the covers of the card. An RF communication method may be used as the method by which the card reader 30 acquires the read information from the card; however, the inventive concept is not limited thereto. Any method may be used without limitation if only the card reader 30 to which power is supplied may wirelessly read the read information attached to the card without a separate power source.

The payment code read information may include information about an act of purchasing the card, and may include, for example, transaction information such as transaction identification information, store code, product information, and transaction amount.

The transaction identification information may be a unique transaction number generated when an approval request is made to a financial server for a transaction, may be used for transaction inquiry or error tracking, and may be necessary to cancel a transaction. The store code may be a combination of alphanumeric and/or numeric codes assigned to a store, and may be used to identify a store at the time of transaction processing. The product information may be a code for identifying a product, and the payment code read information may include product information about a card or product information about a card bundle. The product information about a card bundle may include a plurality of product information corresponding respectively to a plurality of cards included in a card bundle, but is not limited thereto.

The card read information may include information about the card itself and may include, for example, card information and/or item information.

The card information may include card identification information for identifying the card and card function information for identifying the function of the card, and the item information may include item identification information for identifying an item included in the card. However, the card information received from the user terminal 20 may include only card identification information. In this case, the card function information and the item information may be stored in the database 13 in association with the card identification information.

A card may be an article including items that may be used in a game. However, the card may not include an item, and may only include functions that may be used to change the level of another card. A level may be assigned to each card. A card including an item (hereinafter referred to as a “target card”) may determine the performance of the item according to the level. The source card used to change the level of another card may vary in value according to the level. Variables, such as the number of times the level of another card may be changed and how much the level of another card may be changed, may be determined according to the level of the source card. The source card may be used not only to change the level of the target card but also to change the level of the card reader. The source card having a function of changing the level of the target card and the source card having a function of the level of the card reader may be distinguished, but may also be implemented as one source card.

The card function information may be card function-related information indicating whether the card is a target card to be level-changed, a first source card used to change the level of the target card, a second source card used to change the level of the card reader. The source card may be used to change the level of the card to be level-changed, or its value may be destroyed after it is used to change the level of the card reader.

The card may be designed to include only the function of any one of the target card, the first source card, and the second source card, but the inventive concept is not limited thereto. For example, the card may include the functions of two or more of the target card, the first source card, and the second source card. That is, the card may be used as the target card or the first source card or the second source card according to the user's selection. For example, if the first card is the target card including a particular item and at the same time has the function of the first source card, when the item included in the first card is an item that is helpful to the game, the user may use the first card for the game while continuously increasing the level of the first card by using another card having the function of the first source card. On the other hand, when the item included in the first card is an unnecessary item, the first card may be consumed as a source card for changing the level of another card.

The communication unit 11 may transmit at least one of a card account generation notification, card level change display information, and reader level change display information to the user terminal 20. For example, the communication unit 11 may transmit the card account generation notification corresponding to payment code read information to the user terminal 20 that has generated and transmitted the payment code read information. The communication unit 11 may transmit the card level change display information corresponding to card read information to the user terminal 20 that has generated and transmitted the card read information. The communication unit 11 may transmit the level change display information of the reader corresponding to the reader identification information and the card level change display information corresponding to the card read information to the user terminal 20 that has transmitted the reader identification information and the card read information.

The account managing unit 12 may generate a card account corresponding to the card based on the payment code readout information received through the communication unit 11. For example, the account managing unit 12 may generate a card account corresponding to a card based on the payment code read information about a card. As another example, the account managing unit 12 may generate a plurality of card accounts corresponding respectively to a plurality of cards included in a card bundle, based on the payment code read information about the card bundle.

The account managing unit 12 may generate a card account by generating a field for storing information about the card account in the database 13, which will be described later. The field may refer to a predetermined data storage designation region in a storage region of the database 13.

The information about the card account may include at least one of card identification information for identifying the card, card function information indicating whether the card is a level change target card or a level change source card, card level Information indicating the current level of the card, and item identification information for identifying an item included in the card.

According to an aspect, the account managing unit 12 may generate at least one of a card identification information field, a card function information field, a card level information field, and an item identification information field in the database 13.

For example, when receiving first card read information including first card identification information from the communication unit 11, the account managing unit 12 may generate a first card account corresponding to the first card based on the first card read information. For example, in the case where the first card is the level change target card, the account managing unit 12 may store the first card identification information in the card identification information field or store the first card function information indicating that the first card is the level change target card in the card function information field or store the first card level information, for example, default information in the card level information field or store the item identification information of the first card in the item identification information field.

As another example, when receiving second card read information including second card identification information from the communication unit 11, the account managing unit 12 may generate a second card account corresponding to the second card based on the second card read information. For example, in the case where the second card is the source card for changing the level of the level change target card, the account managing unit 12 may store the second card identification information in the card identification information field or store the second card function information indicating that the second card is the level change source card in the card function information field or store the second card level information indicating the value of the second card as the source card for changing the level of the level change target card in the card level information field or store information indicating no item in the item identification information field.

The account managing unit 12 may generate a card account generation notification indicating that a card account has been generated, and the communication unit 11 may transmit the card account generation notification to the user terminal 20.

The account managing unit 12 may inquire the card reader account corresponding to the card reader identification information from the database 13 based on the card reader identification information received through the communication unit 11. If there is no card reader account corresponding to the card reader identification information, a card reader account corresponding to the card reader identification information may be generated. The account managing unit 12 may generate a card reader account by generating a field for storing information about the card reader account in the database 13.

The information about the card reader account may include a card reader identification number, user account information associated with the card reader, card reader level information, and the like.

According to an aspect, the account managing unit 12 may generate at least one of a card reader identification number field, a user account information field, and a card reader level information field in the database 13.

For example, when the communication unit 11 receives the identification information of the first card reader, the account managing unit 12 may inquire the account of the first card reader from the database 13 based on the received identification information. If there is no account of the first card reader, the account managing unit 12 may generate a first card reader account corresponding to the first card reader. The account managing unit 12 may store the identification information of the first card reader in the card reader identification number field, store the first card reader identification information in the user account information field, and store the level information of the first card reader, for example, default information in the card reader level information field.

The account managing unit 12 may generate a card reader account generation notification indicating that a card reader account has been generated, and the communication unit 11 may transmit the card reader account generation notification to the user terminal 20.

The account managing unit 12 may change the property of the target card based on the first card read information that is the card read information of the first card that is the target card and the second card read information that is the card read information of the second card that is the source card. Herein, the second card may be a first source card that may be used as a level change source of the target card. Herein, the property of the target card may include the property of the item included in the target card, the level information of the target card, and the like. Hereinafter, an example of changing the level information of the target card will be described in detail.

The first card read information may include target card identification information. The account managing unit 12 may inquire at least one of the function information, the level information, and the item identification information of the target card from the database 13 by using the target card identification information. The second card read information may include source card identification information. The account managing unit 12 may inquire at least one of the source card function information and the source card level information from the database 13 by using the source card identification information. However, the information stored in the database 13 may be directly stored in the card, read by the user terminal 20, and included in the card read information.

The account managing unit 12 may change the level of the first card by storing the newly changed level information in the card level information field of the first card based on the first card read information and the second card read information.

According to an aspect, the account managing unit 12 may generate new level information of the first card based on the first card read information and the source card read information. The account managing unit 12 may specify the target card whose level is to be changed based on the first card read information as the first card, and inquire the current card level of the first card from the database 13. However, the manner in which the account managing unit 12 acquires the card level of the first, card is not limited to the inquiry from the database 13, but it may be acquired in the form included in the first card read information.

The account managing unit 12 may acquire the second card level information indicating the value of the second card as the source card for changing the level of the target card based on the second card read information, and may generate the newly changed level information of the first card by applying the second card level information to the current card level of the first card that is a specified target card. The account managing unit 12 may store the newly changed first card level information in the card level information field of the first card account.

For example, when the current card level of the first card is the default level and the level of the second card is 1, the account managing unit 12 may add the level 1 of the second card to the default level of the first card to change the level of the first card to 1, and may store the changed level information of the first card in the card level information field of the first card account. The level of the second card may be deducted by the amount consumed in the level change of the first card. For example, when the level 1 of the second card is used to increase the level of the first card by one, the level of the second card may be 0. When the changed level of the second card is 0 after the level of the first card is changed by using the second card, the account managing unit 12 may store new card level information indicating that there is no value as the level change source in the card level information field of the second card. Hereinafter, “reinforcing” the target card may mean an operation of increasing the level of the target card by using the source card.

On the other hand, the communication unit 11 may further acquire source card use information from the user terminal 20. The source card use information may be information indicating how much of the value of the source card is to be used to change the target card level. For example, when the current card level of the first card is the default level and the level of the second card is 2 and the source card use information is 1, the account managing unit 12 may consume only the level 1 among the level 2 of the second card in the default level of the first card from the user and add 1 to the default level (0) to change the level of the first card to 1, and may store the changed level information of the first card in the card level information field of the first card account. Also, the account managing unit 12 may change the level of the second card from 2 to 1 remaining after consumption, and store the changed level information of the second card in the card level information field of the second card account.

On the other hand, the source card use information may be directly input to the user terminal 20 by the user, but may be set to a predetermined default value.

When the information stored in the card level information field is changed, the account managing unit 12 may generate the card level change display information and the communication unit 11 may transmit the card level change display information to the user terminal 20.

According to an aspect, when the newly changed target card level information of the target card is stored in the card level information field of the target card account, the account, managing unit 12 may generate new target card level display information. For example, when the level information “level 1” is stored in the card level information field of the first card account that is the target card, the account managing unit 12 may display the display information indicating that the card level of the first card has been changed to “level 1” and transmit the same to the user terminal 20 through the communication unit 11.

According to another aspect, when the new source card level information of the source card is stored in the card level information field of the source card account due to the use of the source card, the account managing unit 12 may generate new source card level display information. For example, when the level information “level 0” is stored in the card level information field of the second card account that is the source card, the account managing unit 12 may display the display information indicating that the second card may no longer be utilized as a source card and transmit same to the user terminal 20 through the communication unit 11.

As another example, when the level information in which the value as the level change source remains, such as “level 1”, is stored in the card level information field of the second card account that is the source card, the account managing unit 12 may generate the display information indicating how many times the second card may be used as the source card in the future, and transmit the generated display information to the user terminal 20 through the communication unit 11.

On the other hand, the account managing unit 12 may directly change the level information of the target card as described above, but may also change the experience value information capable of changing the level. For example, the level of the target card may be set to be upgraded only when a predetermined amount of experience value is filled. In detail, it may be set such that the level of the target card is increased by 1 only when the experience value is filled with 100%. In this case, the account managing unit 12 may change the experience value information of the first card based on the first card read information that is the card read information of the first card that is the target card and the second card read information that is the card read information of the second card that is the source card. That is, in the above description, the level information may be replaced with the experience value information. The change degree of the experience value information of the first card may be determined according to the current level of the first card, the level of the second card, the source card use information, and the level of the card reader.

The account managing unit 12 may change the property of the card reader based on the identification information of the card reader and the third card read information that is the card read information of the third card that is the second source card. Herein, the third card may be a second source card that may be used as a level change source of the card reader. Herein, the property of the card reader may be the level information of the card reader. The level information of the card reader may be stored in the database 13. To this end, the communication unit 11 may receive the third card information read by the card reader 30 as the second source card information from the user terminal 20. That the communication unit 11 receives the third card information as the second source card information may mean that when the user inputs a second source card information reception request at the user terminal 20 and thus the second terminal 20 is in a standby state, the user terminal 20 receives the read information of the third card through the card reader 30 and thus the user terminal 20 transmits the third card read information and information including the content indicating that the third card read information is acquired as the second source card to the communication unit 11.

The account managing unit 12 may inquire the level information of the card reader from the database 13 by using the identification information of the card reader. The third card read information may include source card identification information. The account managing unit 12 may inquire at least one of the source card function information and the source card level information from the database 13 by using the source card identification information. However, the information stored in the database 13 may be directly stored in the card, read by the user terminal 20, and included in the card read information.

The account managing unit 12 may change the level information of the card reader stored in the level information field of the card reader in the database based on the card reader identification information and the third card read information.

According to an aspect, the account managing unit 12 may generate new level information of the card reader based on the card reader identification information and the third card read information. The account managing unit 12 may specify a target card reader to be level-changed based on the card reader identification information, and inquire the current level of the card reader from the database 13.

The account managing unit 12 may acquire the third card level information indicating the value of the third card as the source card for changing the level of the card reader based on the third card read information, and may generate the newly changed level information of the card reader by applying the third card level information to the current card level of the card reader. The account managing unit 12 may store the newly changed card reader level information in the level information field of the card reader account.

For example, when the current level of the card reader is the default level and the level of the third card is 1, the account managing unit 12 may add the level 1 of the second card to the default level of the card reader to change the level of the card reader to 1, and may store the changed level information of the card reader in the level information field of the card reader account. The level of the third card may be deducted by the amount consumed in the level change of the card reader. For example, when the level 1 of the third card is used to increase the level of the card reader by the level of the third card may be 0. When the changed level of the third card is 0 after the level of the card reader is changed by using the third card, the account managing unit 12 may store new card level information indicating that there is no value as the level change source in the card level information field of the third card. Hereinafter, “reinforcing” the card reader may mean an operation of increasing the level of the card reader by using the source card.

On the other hand, the communication unit 11 may further acquire source card use information from the user terminal 20. The source card use information may be information indicating how much of the value of the source card is to be used to change the card reader level. For example, when the current card level of the card reader is the default level and the level of the third card is 2 and the source card use information is 1, the account managing unit 12 may consume only the level 1 among the level 2 of the third card and add 1 to the default level (0) to change the level of the card reader to 1, and may store the changed level information of the card reader in the card level information field of the card reader account. Also, the account managing unit 12 may change the level of the third card from 2 to 1 remaining after consumption, and store the changed level information of the third card in the card level information field of the third card account.

On the other hand, the source card use information may be directly input to the user terminal 20 by the user, but may be set to a predetermined default value, for example, “1”.

When the information stored in the card reader level information field is changed, the account managing unit 12 may generate the card reader level change display information and the communication unit 11 may transmit the card reader level change display information to the user terminal 20.

On the other hand, in the above aspects, an operation of reinforcing the target card or the card reader is described on the assumption that the success rate is 100%, but the inventive concept is not limited thereto. For example, the success rate may be set to a value less than 100%. Accordingly, if the user attempts reinforcement by using a source card, the enforcement will succeed or fail. Even if the enhancement fails, the level information of the source card may be deducted by the used amount.

In the above aspects, the level of the card reader may determine the reinforcement success rate of the target card from which the card information is read by the card reader. As the level of the card reader is higher, when the target card and the source card are read by the card reader and the read source card is used to reinforce the target card, the reinforcement rate may be determined to be higher. That is, even if the target card is reinforced by using the same target card and the source card, the reinforcement rate may vary according to the level of the card reader. The level of the card reader may be any one of 1, 2, and 3, but is not limited thereto.

Alternatively, in the above aspects, the level of the card reader may determine the property change degree (e.g., the reinforcement degree) of the target card from which the card information is read by the card reader. As the level of the card reader is higher, when the target card and the source card are read by the card reader and the read source card is used to reinforce the target card, the amount of the property to be changed may be determined differently. That is, the amount of the level to be reinforced may be determined differently.

For example, as the level of the card reader is higher, the property change degree is set to be higher; and as the property change degree is higher, the property of the target card may be changed more. In detail, when an attempt is made to increase the level of the target card by 1 by using the source card, as the level of the reader is higher, the level of the target card may be reinforced more, For example, when the level of the reader is 2 among 1, 2, and 3, the level of the target card may be increased by two times the amount of the level consumed in the source card. For example, when the level of the reader is 3 that is the maximum level, the level of the target card may be increased by three times the amount of the level consumed in the source card. This is a particular example for description, and thus the inventive concept is not limited thereto. When the account managing unit 12 does not directly change the level of the target card but changes the experience value for changing the level of the target card, the experience value for changing the level of the target card may be increased more as the property change degree is higher.

In detail, the account managing unit 12 may change the property of the target card based on the first card read information that is the card read information of the first card that is the target card and the second card read information that is the card read information of the second card that is the source card. In this case, the account managing unit 12 may change the property of the target card by further considering the level information of the card reader reading the first card read information and the second card read information. To this end, the communication unit 11 may receive the identification information of the card reader, the first card read information, and the second card read information from the user terminal 20. Herein, the property may mean the level information of the target card or the property of the item included in the target card.

The account managing unit 12 may acquire the level information of the card reader from the database 13 by using the identification information of the card reader and may change the property of the item included in the target card by further considering the level information of the card reader. However, changing the property of the item may not mean changing the property of the item stored in the card account of the database 13, but may mean applying the property of the item differently when utilizing the item in the game. That is, depending on the level of the card reader that reads the card, even if the game is played by using the same card, other properties may be applied when the item is applied to the game. For example, as the level of the card reader is higher, the ability value of the item included in the card read by the card reader may be set to be higher in the game.

A particular example of changing the level of the first card by using the second card has been already described above, and thus redundant descriptions thereof will be omitted. The account managing unit 12 may inquire the level of the card reader from the database 13 by using the identification information of the card reader. When the level of the first card is changed by using the second card, the account managing unit 12 may set the reinforcement, success rate of the first card differently according to the level of the card reader. The account managing unit 12 may change the level of the first, card probabilistically according to the reinforcement success rate. The account managing unit 12 may set the target card reinforcement, success rate to be higher as the level of the card reader is higher.

The target, card reinforcement success rate may basically be set to a predetermined default value, but it may be set by using variables such as a card reader level, a target, card level, a source card level, and source card use information. Even when the target card reinforcement fails, the account managing unit 12 may subtract the level information of the second card that is the source card, by the amount used to attempt the first card level change that is the target card.

In the above aspects, the level of the target card or the card reader is described as being changed gradually as the source card is consumed, but the inventive concept is not limited thereto. In the case of the card reader, the level change may be set more difficultly than the target card. For example, the level of the card reader may be any of 1, 2, and 3, and the level may be changed by increasing the experience value corresponding to each level by using the second source card. For example, the level of the card reader may be increased by one level by filling 100 experience points for each level, and the experience value may be filled by consuming the level of the second source card.

This level changing method may also be applied to the level change of the target card. For example, the level of the target card may be changed by increasing the experience value corresponding to each level of the target card by using the first source card. For example, the level of the target card may be increased by one level by filling 100 experience points for each level, and the experience value may be filled by consuming the level of the first source card.

When the level changing method is applied to the level change of the target card, the increase degree of the experience value may be changed according to the level of the card reader. For example, even when the same first source card is used to increase the experience value of the target card, the experience value of the target card may increase more as the level of the card reader is higher.

It may be possible to design in various ways as to how the level of the second source code affects the change of the level of the card reader.

In the above aspects, an example in which a card is used as a source for changing the level of a target card or a card reader has been described, but the inventive concept is not limited thereto. For example, a source item that may be physically connected to a card reader to transmit source information to a card reader, may replace the source card, or various types of structures in which a radio frequency module may be installed may replace the source card. The card reader may read the source information by communicating with the radio frequency module.

The account managing unit 12 may change the level of the target card by a plurality of levels based on the target card read information of the target card and a plurality of source card read information of a plurality of source cards.

The database 13 may store information about the card account. The database 13 may store and change information about at least one card account under the control of the account managing unit 12.

As such, according to the aspects of the presently disclosed embodiment, the utility of a game card may be improved by utilizing the source card, which is a dummy card, to change the card level of the target card.

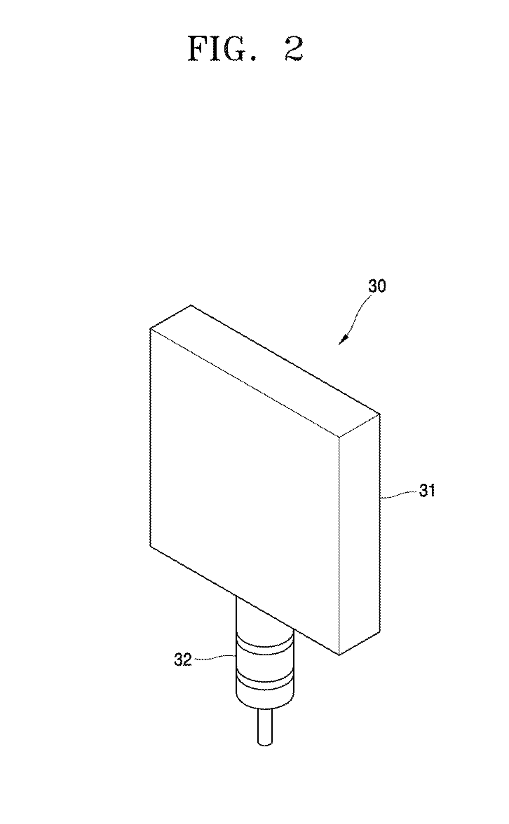

FIG. 2 schematically illustrates the card reader 30. Referring to FIG. 2, the card reader 30 may include a main body 31 and a connector 32.

The main body 31 may include a reading module capable of reading card information and a storage module capable of storing identification information of the card reader 30. The reading module may read the card read information from the card in a contact or non-contact manner, and the read card read information may be transmitted to the user terminal 20 through the connector 32. The reading module may read the card information in an RF manner, but is not limited thereto. The identification information of the card reader 30 may also be transmitted to the user terminal 20 through the connector 32.

The connector 32 may be attached to the main body 31 to transmit/receive information through a connection port of the user terminal 20. The connection port may include, for example, a microphone connection terminal or an earphone connection terminal. The connector 32 may be manufactured in the form conforming to the specification of the connection port of the user terminal 20.

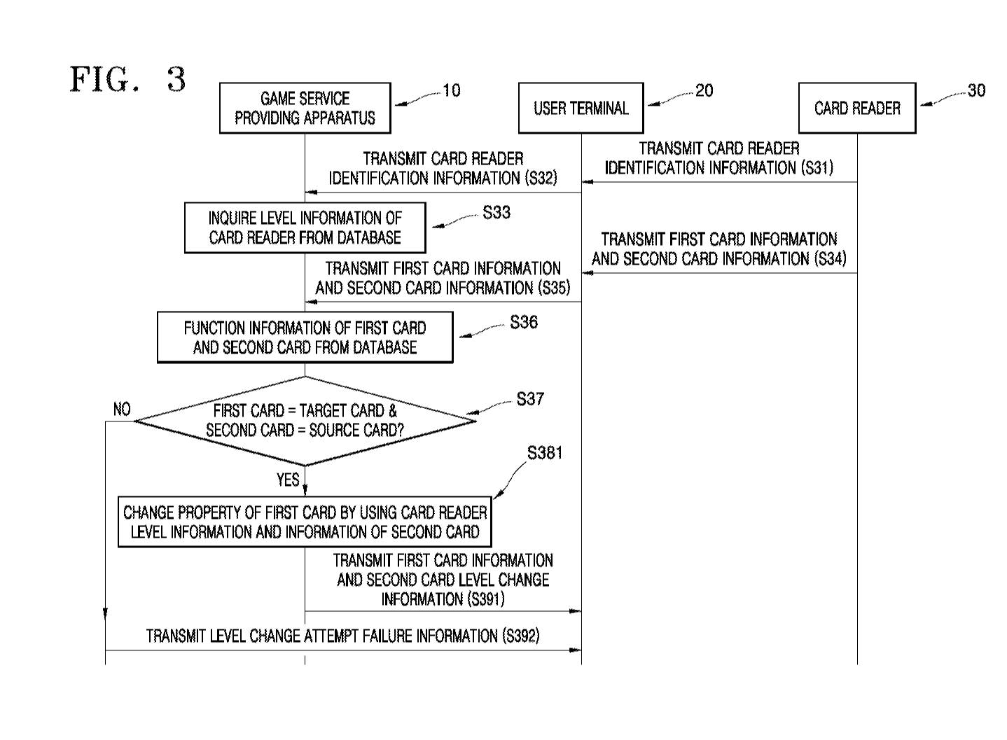

FIG. 3 is a flow diagram illustrating a game service providing method according to an aspect of the presently disclosed embodiment.

The flow diagram illustrated in FIG. 3 may include the sequential operations of the game service providing apparatus 10, the user terminal 20, and the card reader 30 illustrated in FIGS. 1 and 2. Thus, it will be understood that the contents described above with respect to the configurations illustrated in FIG. 1 and 2 may also be applied to the flow diagram illustrated in FIG. 3, even if omitted from the following description.

Referring to FIG. 3, in operation S31, when the card reader 30 is attached to the user terminal 20, the card reader 30 transmits the card reader identification information to the user terminal 20. For example, when the user inputs a card reader identification information transmission request to the user terminal 20 after the card reader 30 is attached to the user terminal 20, the user terminal 20 may receive the card reader identification information from the card reader 30.

In operation S32, the user terminal 20 transmits the card reader identification information received in operation S31 to the game service providing apparatus 10.

In operation S33, the game service providing apparatus 10 inquires the level information of the card reader 30 from the database by using the card reader identification information received in operation S32. Since a variety of information related to the card reader corresponding to the card reader identification information is stored in the database, the game service providing apparatus 10 may inquire the level information of the card reader by using the card reader identification information.

In operation S34, the card reader 30 reads the first card information from the first card approaching or contacting the card reader 30, reads the second card information from the second card approaching or contacting the card reader 30, and transmits the read information to the user terminal 20. The card reader 30 may transmit the first card information as the target card information and the second card information as the first source card information. For example, when the card reader 30 transmits the first card information to the user terminal 20 after the user inputs a target card information transmission request to the user terminal 20, the first card information may be transmitted as the target card information to the user terminal 20, and when the card reader 30 transmits the second card information to the user terminal 20 after the user inputs a first source card information transmission request to the user terminal 20, the second card information may be transmitted as the first source card information to the user terminal 20. The first source card may mean a card that may be used to change the level of the target card as described above. The card information may include unique identification information of the card.

In operation S35, the user terminal 20 transmits the first card information and the second card information received in operation S34 to the game service providing apparatus 10. In operation S35, the user terminal 20 may receive source card use information indicating how much of the value of the second card is to be used to change the property of the first card from the user, and transmit the source card use information to the game service providing apparatus 10.

In operation S36, the game service providing apparatus 10 uses the first card information and the second card information to inquire the function information of the first card from the database and inquire the function information of the second card from the database.

In operation S37, the game service providing apparatus 10 determines whether the first card to which the information is inputted as the target card is actually the target card, whether the second card to which the information is inputted as the first source card is actually the first source card. In detail, it is determined whether the target card function is included in the function information of the first card inquired from the database or the first source card function is included in the function information of the second card. When the first card includes the target card function and the second card includes the first source card function, the process proceeds to operation S381. When any one of the conditions is not satisfied, the process proceeds to operation S392.

In operation S381, the game service providing apparatus 10 changes the property of the first card by using the card reader level information and the information of the first card and the second card. In detail, the game service providing apparatus 10 inquires the level information of the first card from the database by using the information of the first card, and inquires the level information of the second card from the database by using the information of the second card. Thereafter, the level information of the first card is changed. In detail, the level of the first card may be increased and the level of the second card may be decreased.

In operation S381, when the game service providing apparatus 10 further receives the source card use information in operation S35, the game service providing apparatus 10 may change the level information of the first card by considering the level information of the second card corresponding to the identification information of the second card, the level information of the first card corresponding to the identification information of the first card, and the source card use information. In detail, the level corresponding to the source card use information may be added to the level of the first card, and the level corresponding to the source card use information may be subtracted from the level of the second card. If the level of the second card is exhausted, for example, the level becomes 0, the second card may no longer function as the first source card.

According to an aspect, instead of unconditionally changing the level information of the first card, the game service providing apparatus 10 may set a predetermined property change success rate and change the property of the first card probabilistically according to the property change success rate. In this case, the property change success rate may be set to be higher as the level information of the card reader 30 is higher.

In operation S391, the game service providing apparatus 10 transmits the first card and second card level change information to the user terminal 20.

When proceeding from operation S37 to operation S392, the game service providing apparatus 10 transmits information indicating that the level change attempt has failed to the user terminal 20 in operation S392.

Although not illustrated in FIG. 3, the user terminal 20 displays the information received from the game service providing apparatus 10 in operation S391 or S392 on the screen.

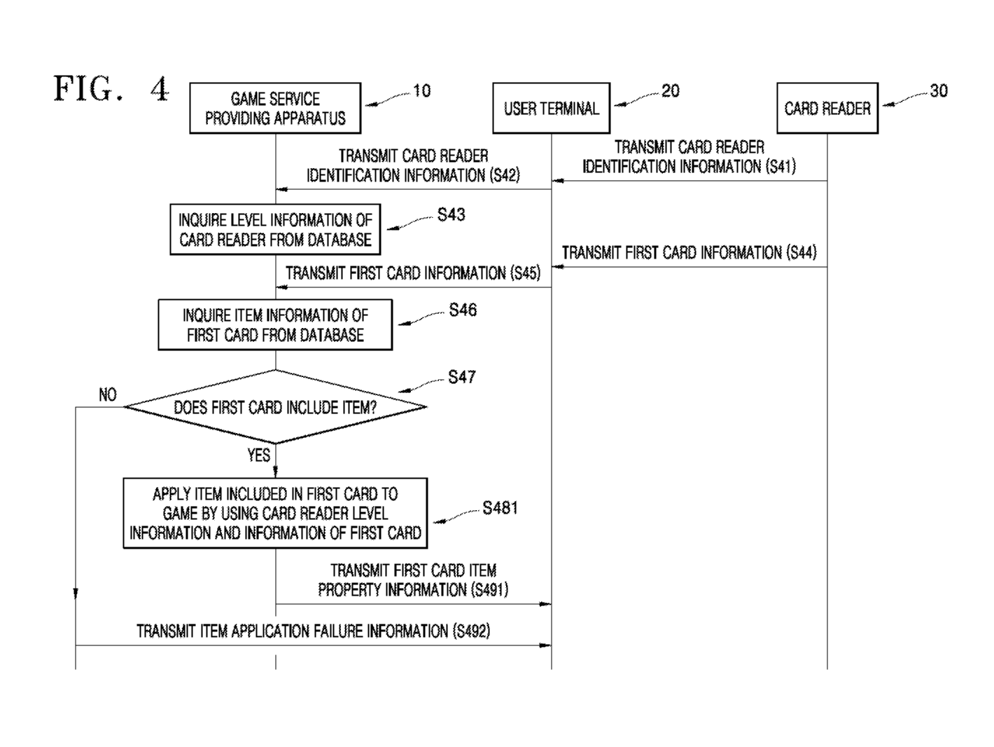

FIG. 4 is a flow diagram illustrating a game service providing method according to another aspect of the presently disclosed embodiment.

The flow diagram illustrated in FIG. 4 may include the sequential operations of the game service providing apparatus 10, the user terminal 20, and the card reader 30 illustrated in FIGS. 1 and 2. Thus, it will be understood that the contents described above with respect to the configurations illustrated in FIG. 1 and 2 may also be applied to the flow diagram illustrated in FIG. 4, even if omitted from the following description.

Referring to FIG. 4, in operation S41, when the card reader 30 is attached to the user terminal 20, the card reader 30 transmits the card reader identification information to the user terminal 20. For example, when the user inputs a card reader identification information transmission request to the user terminal 20 after the card reader 30 is attached to the user terminal 20, the user terminal 20 may receive the card reader identification information from the card reader 30.

In operation S42, the user terminal 20 transmits the card reader identification information received in operation S41 to the game service providing apparatus 10.

In operation S43, the game service providing apparatus 10 inquires the level information of the card reader 30 from the database by using the card reader identification information received in operation S42. Since a variety of information related to the card reader corresponding to the card reader identification information is stored in the database, the game service providing apparatus 10 may inquire the level information of the card reader by using the card reader identification information.

In operation S44, the card reader 30 reads the first card information from the first card approaching or contacting the card reader 30, and transfers the first card information to the user terminal 20. The card reader 30 may transmit the first card information as the item card information. For example, when the card reader 30 transmits the first card information to the user terminal 20 after the user inputs an item card information transmission request to the user terminal 20, the first card information may be transmitted as the item card information to the terminal 20. The first card may be a card including an item available for a game, and the card information may include unique identification information of the card.

In operation S45, the user terminal 20 transmits the first card information received in operation S44 to the game service providing apparatus 10.

In operation S46, the game service providing apparatus 10 uses the first card information to inquire the item information of the first card from the database. In detail, the item information corresponding to the identification information of the first card may be inquired and received from the database.

In operation S47, the game service providing apparatus 10 determines whether the first card is a card including an item. In detail, it may be determined whether the item information of the first card inquired from the database includes one or more items. If the first card includes an item, the process proceeds to operation S481. If not, the process proceeds to operation S492.

In operation S481, the game service providing apparatus 10 applies the items included in the first card to the game by using the card reader level information and the information of the first card. Applying the item included in the first card to the game may mean that processing is performed such that the item included in the first card may be used when the game provided by the game service providing apparatus 10 is performed with the user account in which the present user terminal 20 is logged in or with the user account associated with the card reader and the first card.

In detail, the game service providing apparatus 10 uses the information of the first card to inquire item information of the first card from the database, and applies the item included in the first card to the game. When applying the item included in the first card to the game, the game service providing apparatus 10 may apply the item to the game by changing the property of the item according to the card reader level information. That is, even when an item is applied to a game by using the same card, the item property may be applied differently according to which card reader is used to read the card information. For example, as the level of the card reader 30 is higher, the game service providing apparatus 10 may further improve the property of the item and apply the same to the game.

In operation S491, the game service providing apparatus 10 transmits the first card item property information to the user terminal 20. The user terminal 20 may receive information about which property the item included in the first card has been applied to when applied to the game.

When proceeding from operation S47 to operation S492, the game service providing apparatus 10 transmits information indicating that the item application has failed to the user terminal 20 in operation S492. In detail, information indicating that an item is not included in the first card may be transmitted to the user terminal 20.

Although not illustrated in FIG. 4, the user terminal 20 displays the information received from the game service providing apparatus 10 in operation S491 or S492 on the screen.

In the aspects of the presently disclosed embodiment described above, the level of the target card or the card reader is described as numeric, but the inventive concept is not limited thereto. For example, the level of the target card or card reader may be expressed as a rank of high level, medium level, or high level, or may be expressed as tribe information such as heart, diamond, and clover. The rank relationship between the ranks or tribes may be preset.

The tribes may be set to have advantages and disadvantages without the rank relationship therebetween. In this case, if the first card is reinforced by using the second card, the tribe of the first card may be changed to be the same as the tribe of the second card. Alternatively, when playing the game by using the first card, the tribe of the first card may be changed to be the same as the tribe of the card reader.

Meanwhile, the game service providing methods according to the aspects of the presently disclosed embodiment illustrated in FIGS. 3 and 4 may be written as computer programs and may be implemented in general-purpose digital computers that may execute the programs by using a computer-readable recording medium. Examples of the computer-readable recording medium may include storage mediums such as magnetic storage mediums (e.g., ROMs, floppy disks, and hard disks) and optical recording mediums (e.g., CD-ROMs and DVDs).

Although the presently disclosed embodiment has been described with reference to the aspects illustrated in the drawings, this is merely an example and those of ordinary skill in the art will understand that various modifications may be made therein. Thus, the spirit and scope of the presently disclosed embodiment should be defined by the appended claims.

What is claimed is:

1. A game service providing method for providing a game service by a game service providing apparatus, the game service providing method comprising:
receiving identification information of a card reader attached to a user terminal from the user terminal;
receiving level information of the card reader from a database by using the identification information of the card reader;
receiving, from the user terminal, first card information read from a first card by the card reader as target card information and receiving second card information read from a second card by the card reader as first source card information; and
changing a property of the first card by using the second card information and the level information of the card reader,
wherein the changing comprises changing the property of the first card or setting a property change success rate of the first card differently according to the level information of the card reader.

2. The game service providing method of claim 1, further comprising, after the receiving of the first card information and the second card information, inquiring function information of the first card and the second card and level information of the first card from the database by using the first card information and the second card information,
wherein the changing comprises changing level information of the first card or experience value information for changing the level information when the function information of the first card comprises a target card function and the function information of the second card comprises a source card function,

3. The game service providing method of claim 1, wherein the changing comprises:
setting a property change success rate to be higher as the level information of the card reader is higher; and
changing the property of the first card probabilistically according to the property change success rate.

4. The game service providing method of claim 1, wherein the changing comprises:
setting a property change degree to be higher as the level information of the card reader is higher; and
changing the property of the first card more as the property change degree is higher.

5. The game service providing method of claim 1, wherein
the first card information comprises identification information of the first card and the second card information comprises identification information of the second card,
the receiving of the first card information and the second card information comprises further receiving source card use information indicating how much value among the value of the second card is to be used to change the property of the first card, and
the changing of the property of the first card comprises changing level information of the first card by considering level information of the second card corresponding to the identification information of the second card, level information of the first card corresponding to the identification information of the first card, and the source card use information.

6. A game service providing apparatus comprising:
a communication unit configured to receive identification information of a card reader attached to a user terminal from the user terminal, receive, from the user terminal, first card information read from a first card by the card reader as target card information, and receive second card information read from a second card by the card reader as first source card information; and
an account managing unit configured to receive level information of the card reader from a database by using the identification information of the card reader and change a property of the first card by using the second card information and the level information of the card reader,
wherein the account managing unit changes the property of the first card or sets a property change success rate of the first card differently according to the level information of the card reader.

7. The game service providing apparatus of claim 6, wherein the account managing unit inquires function information of the first card and the second card and level information of the first card from the database by using the first card information and the second card information and changes the level information of the first card when the function information of the first card comprises a target card function and the function information of the second card comprises a source card function as a result of the inquiring.

8. The game service providing apparatus of claim 6, wherein the account managing unit sets a property change success rate to be higher as the level information of the card reader is higher, and changes the property of the first card probabilistically according to the property change success rate.

9. The game service providing apparatus of claim 6, wherein the account managing unit sets a property change degree to be higher as the level information of the card reader is higher, and changes the property of the first card more as the property change degree is higher.

10. The game service providing apparatus of claim 6, wherein
the first card information comprises identification information of the first card and the second card information comprises identification information of the second card,
the communication unit further receives source card use information indicating how much value among the value of the second card is to be used to change the property of the first card, and
the account managing unit changes level information of the first card by considering level information of the second card corresponding to the identification information of the second card, level information of the first card corresponding to the identification information of the first card, and the source card use information.

11. A game service providing method for providing a game service by a game service providing apparatus, the game service providing method comprising:
receiving identification information of a card reader attached to a user terminal from the user terminal;
receiving level information of the card reader from a database by using the identification information of the card reader;
receiving, from the user terminal, first card information read from a first card by the card reader; and
receiving item information corresponding to the first card information from the database and setting a property of the item differently according to the level information of the card reader and then applying the item to a game.

12. A computer program stored on a medium to execute the game service providing method of claim 1 by using a computer.
